(19) United States
(12) Patent Application Publication
(10) Pub. No.: US 2008/0156582 A1
(43) Pub. Date: Jul. 3, 2008

(54) TALL STRUCTURE EXTERNAL EMERGENCY ESCAPE SYSTEM

(76) Inventor: Johannes H. Egbers, Hockessin, DE (US)

Correspondence Address: Connolly Bove Lodge & Hutz LLP, P.O. Box 2207, Wilmington, DE, 19899-2207, US

(21) Appl. No.: 11/619,345

(22) Filed: Jan. 3, 2007

(51) Int. Cl. A62B 1/16

(52) U.S. Cl. 182/5

(57) ABSTRACT

A tall structure external emergency escape system comprises a platform which is movable to and from a generally vertical position of non-use and a generally horizontal position of use. A cable system is mounted to the platform. The cable system includes a cable having a fixed end and a free end. The fixed end is mounted to an anchor mechanism on the platform. The free end is capable of extending downwardly from the platform to a receiving area. The system further includes a sling/harness which would be worn by a person. A clamp mechanism secures the sling/harness to the cable.

### BACKGROUND OF INVENTION

Airline passengers and crews are provided with individual escape and rescue equipment in case of an aviation emergency. Ships have rescue equipment available for all people on board to survive during emergency situations. Automobiles are increasingly equipped with systems that make survival more likely during accidents. People working in high-rise structures, however, have very limited ways to escape when downward exits are blocked by smoke, toxic chemicals or fire. Only slow and high risk helicopter attempts can then be made. In a time of increasing global terrorism more may need to be done to insure that occupants of high-rise structures can safely escape during a catastrophic event.

### SUMMARY OF INVENTION

An object of this invention is to provide an emergency escape system that could be used externally of a tall structure or building.

A further object of this invention is to provide such an escape system which would be particularly useful and unaffected by internal escape routes, such as stairways being blocked.

In accordance with this invention the tall structure external emergency escape system includes a launching platform which would be mounted as an integral part of a new or retro-fitted building structure and would be mounted in such a manner that it could be moved from a first generally vertical position during periods of non-use to a second generally horizontal position when it is needed for escape purposes. Thus, during normal conditions the platform could generally conform to the external appearance of the structure. Under emergency conditions, however, the platform could be moved to its escape position. A cable system is mounted to the platform which includes a cable having one end fixed at the platform and a free end which may be lowered from the platform to function as a track which a person may use to be lowered from the platform to a receiving area. To accomplish this a sling/harness would be worn by the person and a clamp mechanism would attach the sling/harness to the cable to control the descendance of the person down the cable.

In a preferred practice of this invention the free end of the cable would be locked at the ground zero level or receiving area to create a rigid cable system. The clamp mechanism is preferably adjustable in tension to control the rate of descent down the cable. The clamp mechanism is also preferably of a quick release type so that once a person has reached ground level the clamp mechanism can be immediately disengaged from the cable so as not to interfere with the next person who is descending down the cable.

### THE DRAWINGS

FIG. 1 is a perspective view of a tall structure or building showing various locations for the escape system of this invention;

FIG. 2 is a perspective view showing use of the escape system of this invention;

FIG. 3 is a front elevational view of a clamp mechanism which may be used in the escape system of this invention;

FIG. 4 is a right side elevational view of the clamp mechanism shown in FIG. 3;

FIG. 5 is a rear elevational view of the clamp mechanism shown in FIGS. 3-4;

FIG. 6 is a top plan view of the clamp mechanism shown in FIGS. 3-5;

FIG. 7 is a cross sectional view taken through FIG. 3 along the line 7-7; and

FIG. 8 is a fragmental front elevational view of the clamp mechanism of FIGS. 3-7 in its open condition.

### DETAILED DESCRIPTION

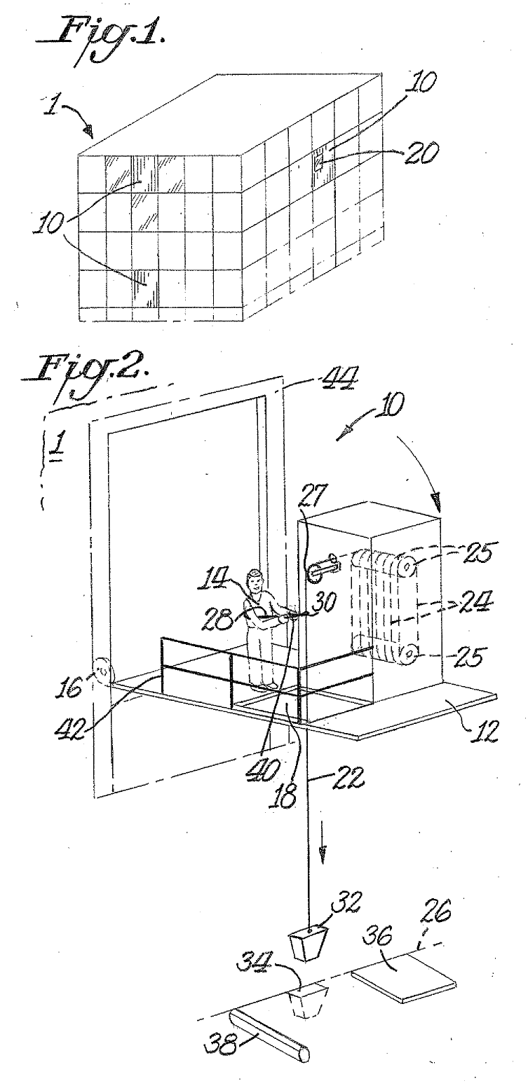

FIG. 1 illustrates a portion of a tall structure or multi-story building 1 which is provided with one or a multiple of external emergency escape systems 10 at various suitable locations. The purpose of such external emergency escape system 10 is to enable an evacuation from the building 1 which is continuous and fast. The building occupants would be able to escape the building in a manner in which the occupants are able to self manage and act quickly and immediately without assistance from professional rescue organizations. The emergency equipment of system 10 can operate without external energy supply since external power is often interrupted during an emergency.

An additional benefit from the preferred form of escape system 10 is that it does not affect the structure's external appearance and could be incorporated in the building at reasonable costs. As generally illustrated in FIG. 1 each system 10 forms an integral part of the building structure and has an external shape or appearance during conditions of non-use that generally conform to the external appearance of the structure.

FIG. 2 shows the basic components of the tall structure external escape system 10. As shown therein system 10 includes a launching platform 12 which is movable to and from a first generally vertical position (illustrated in FIG. 1) during periods of non-use so that the system thereby generally conforms to the external appearance of the structure or building 1. Platform 1 is illustrated in FIG. 2 as being movable to a second generally horizontal position for supporting a person 14 who would desire to escape from the building 1 during emergency conditions. Platform 12 can be moved to and from the first generally vertical position and the second generally horizontal position in any suitable manner. In the preferred practice of this invention platform 12 is mounted to building 1 by a hinge or pivot structure 16 of any suitable construction which would permit platform 12 to be moved. Such movement could be done manually when no energy source is available or such movement could be power operated by an external power source, such as a battery operated unit, independent of the power sources in building 1. Thus, platform 12 can be rotated 90° from the vertical position to the horizontal position and when in the horizontal position, the outer edge of platform 12 could extend about 10-12 ft. outside of the structure 1.

Platform 12 acts as an external shield to insure that the exterior aesthetics of the structure are not negatively affected when platform 12 is in the vertical condition. In order to enhance the aesthetic appearance of platform 12 a “fake” or temporary window could be provided on the external surface where platform 12 would be located so as to create an appearance that conforms to the other portions of the structure 1 having windows. The “fake” window would preferably conform in size and shape to the permanent windows of building 1. Thus, if building 1 contains windows from floor to ceiling, the temporary or fake window could be disposed externally of platform 12 over the same size and shape as the permanent windows which could even result in completely covering platform 12. Where such temporary or fake window is provided the temporary window must be removed without letting it fall from great heights. This can be accomplished in various ways depending on the structure's design. The purpose of the temporary window, as noted, is to maintain the structure's aesthetics. The temporary window should not be part of the platform in its horizontal position because it would interfere with the escape opening. In that regard, FIG. 2 illustrates an escape opening 18 located in platform 12. In one practice of the invention where the permanent windows are of a similar size and shape to escape opening 18 the temporary window could be mounted across the opening 18. FIG. 1, for example, shows one such temporary window 20. When it is intended to use the platform 12 as part of the escape system, such window 20 would first be removed to expose the escape opening 18.

One of the features of the system 10 is the provision of a cable system which basically involves having a cable 22 anchored at one end and which may be considered a fixed end to an anchor system 24 mounted on platform 12. As illustrated in FIG. 2 the anchor system 24 includes a plurality of pulleys 25,27 over which the cable 22 passes so that cable 22 is disposed directly above the escape opening 18. The other, or free end, of the cable 22 would be lowered to a location or receiving area where the person 14 would descend. Preferably, that level would be the ground zero level 26. If the ground zero level 26 is considered to be too far below platform 12 so as to create apprehension or fear in the person being lowered, the person could be lowered in stages by having an upper escape system 10 located directly above a lower escape system 10. FIG. 1, for example, shows two such escape systems vertically in line with each other. Any suitable number of aligned escape systems could be used which would be operated in a manner that a person from a higher level would be lowered from the high level escape system to the next lower level escape system, etc. until the person is lowered to the ground. Where aligned systems are used, the escape openings 18 might be staggered from one system to the other.

As also illustrated in FIG. 2 a sling or harness 28 would be worn by the person and a is clamp mechanism 30 would connect the sling/harness to the cable 22 so that the cable 22 then functions as a track while the person descends through the escape opening 18 to the receiving level 26.

Preferably the clamp mechanism 30 is of the quick release type to permit the person to immediately become disengaged from the cable so as to not interfere with the next person descending.

In the preferred practice of this invention the clamp mechanism 30 is also of a type which provides adjustable cable tension so as to control the rate of descendency of the person 14. For example, the sling/harness 28 could be an underarm sling, such as used by the coastguard helicopter rescue missions. The lightweight cable clamp 30 would be fastened to the escape cable 22 and preadjusted for different weight categories of the employee or visitor. Such weight categories could be, for example, 100-150 lbs., 150-200 lbs., 200-250 lbs. and 250 lbs. and above. Any suitable pretension clamp cable could be used which would regulate the speed of the person descending from platform 12. Each person would be provided with his/her own sling/harness and clamp mechanism.

Preferably, the fixed end of cable 22 is mounted to anchor system 24 which includes any suitable cable assembly that automatically unwinds the cable when the platform 12 is lowered to its final extended horizontal position with the help of an energy source or manually with the help of a weight 32 mounted to the free end of cable 22.

The ground level station would include a cable locking device 34 and could optionally include a cushion 36. Cushion 36 could be a foam type pad. More preferably, however, cushion 36 is an air cushion since it would occupy less space and could be quickly inflated. The purpose of a cushion is to soften the landing of the escapees. The small ground level station can be easily camouflaged during non-emergency times with art and decorative fencing that can easily be removed during an emergency. FIG. 2 illustrates schematically by the reference numeral 38 some form of cover or camouflage structure which would cover the cable locking device 34 and the cushion 36 during periods of non-use and could be readily removed during use of system 10.

Any form of cable locking device 34 can be used in accordance with this invention. Such cable locking device could simply be an anchor member to which the free end of cable 22 would be attached once the cable 22 is sufficiently lowered from platform 12. For example, the free end of cable 22 could have a loop that engages a hook type anchor member or locking device. Preferably, the locking device 34 is a self-locking system which would be triggered by, for example, the cable weight 32 contacting the locking device 34. For example, the locking device 34 could have a shape which is complementary to the shape of the weight 32 such as both being a conical or trapezoidal design and the locking device 34 is triggered when the weight 32 enters the locking device 34. Rods or suitable spring biased horizontal members could be activated to trap weight 32 in device 34. By anchoring each end of cable 22 a rigid cable system is formed which facilitates the person properly and safely descending from platform 12.

Preferably, for each building having a system 10 a person would be trained to ensure that the cable weight 32 enters the self-locking system and guides it into the locking system in case of strong winds. Since the ground station can be camouflaged with landscaping or some form of cover, it will not require much space. Minimal space is taken by the cushion 36 where the cushion is a self-inflating air cushion.

In use, during an emergency condition assigned personnel would remove or open the temporary window 20 such as by use of a hinged sideward movement if allowed by the subject's architecture. Such fake or temporary window is preferably made using light-weight materials so as to facilitate its removal.

The assigned personnel would then rotate the platform 12 away from the side of structure 1. This could be done manually or with a battery operated mechanism. The cable weight release system in anchor system 24 unfolds when the platform 12 has reached its operating position. The cable weight 32 descends automatically into the ground self-locking device 34.

All previously trained persons then enter the platform 12. Each person attaches his/her personal sling/harness which includes the clamp mechanism 30. The clamp mechanism 30 is then attached to the cable 22. The person 14 can hold handgrips 40 on mechanism 30.

FIG. 2 illustrates the preferred practice of the invention where the escape opening 18 is a cutout in platform 12. For safety reasons a fence or suitable guard structure 42 would be provided around the safety opening 18 and/or completely around the periphery of platform 12 so that a person would not accidentally fall from the platform and to give the escapees a feeling of security.

It is to be understood, however, that the invention could be broadly practiced where the cable is extended over the side of platform 12 and the person would descend by stepping off platform 12 thereby omitting a separate escape opening. Such manner of operation, however, is not as preferred since the illustrated embodiment offers more safety and reassurance to the escapees.

Once a person has begun descent down cable 22 the next person would immediately come forward and attach his/her weight tested clamp as soon as the previous person descended under the platform level. When a person 14 arrives at zero level 26 the person pulls the quick release device of the clamp mechanism 30 to remove the clamp and then progresses to a predetermined area site so that an immediate record is available of those who escaped.

It is assumed that a platform and cable installation can be ready for use within a ten minute period. A descent of six persons per minute should be possible allowing for an evacuation of 360 persons per hour per platform. For a 30-40 story building the time to descent should be about one-two minutes assuming a descent rate of about six or seven miles per hour which is a fast walking speed. For extreme tall structures a phased platform system, as previously described, may be necessary allowing people to escape to a lower level platform depending on the design of the structure.

To enhance acceptance by personnel of the use of system 10 it would be desirable if the personnel had some familiarity with the system 10 and a feeling of confidence in the knowledge that the system would work. This can be achieved by exposing personnel to the system under non-emergency conditions and/or by the provision of training modules. For example, a training module could involve a platform 12 with the associated cable system but not necessarily be attached to a building or could be temporarily attached to the building. Thus, it is not necessary that the platform 12 in the training module be movable to and from the generally vertical to the generally horizontal positions. Instead, as a training module the platform 12 may be permanently in a horizontal position. The various components of the training module could be telescoped during periods of non-use and transportation to minimize space requirements. As a training module platform 12 would be elevated a suitable height, such as one, two or higher stories by any suitable elevating mechanism including having a fixed height or an adjustable height through, for example, the use of a scissors type construction or by being temporarily attached to the building. When at the selected height the personnel could then practice using system 10 by activating the rigid cable mechanism, putting on the sling/harness 28, attaching the clamp mechanism 30 and then descending from platform 12.

Such training modules could thus be incorporated in mobile structures and could be shared by multiple tall structure operators or perhaps rented.

Under actual emergency conditions when a specific alarm signal is given trained personnel would be assigned to rotate the platform 12 and bring it to its escape position shown in FIG. 2. The anchor system 24 would then automatically unwind the cable 22. Trained employees or emergency personnel should ensure that the ground station is ready for the cable to be locked in place and any optional air cushion is inflated or foam cushion is properly located. Every employee should unpack his/her personal sling jacket and clamp, put the sling jacket on and proceed to the escape platform according to a predetermined number system. At the platform the person would place the clamp on the cable, close and secure the clamp and jump. Once on ground level the escapee could quickly release the clamp from the cable.

During conditions of non-use the platform 12 would be rotated from the generally horizontal position shown in FIG. 2 to a generally vertical position so that the support surface of platform 12 and the anchor system 24 and other components on platform 12 would fit through the framework 44 of building 1 and would extend inside the building. As a result, only the exterior surface or lower surface of platform 12 would be visible in the vertically disposed orientation shown in FIG. 1 and such outer surface could be completely or partially covered by the temporary or “fake” window 20.

When the free end of cable 22 has reached the receiving area, further unwinding of the cable is prevented. This could be done by manually actuating a braking mechanism in the anchor system 24 and then locking the cable assembly of the anchor system to prevent further unwinding movement. Alternatively, such braking/locking action could be automatically performed in response to the free end of the cable 22 being received in the locking mechanism 34. Another alternative is to provide a cable 22 of a predetermined length which corresponds to the length of the cable that would be required for the cable to reach the receiving area. Thus, when the free end of the cable 22 reaches the receiving area the fixed end of the cable remains fixed to the cable assembly in anchor system 24 and there is no further length of cable to be unwound. By preventing further unwinding of the cable, a rigid cable system is assured wherein both the free end and fixed end of the cable can not vertically move so as to facilitate the escapee descending down the cable.

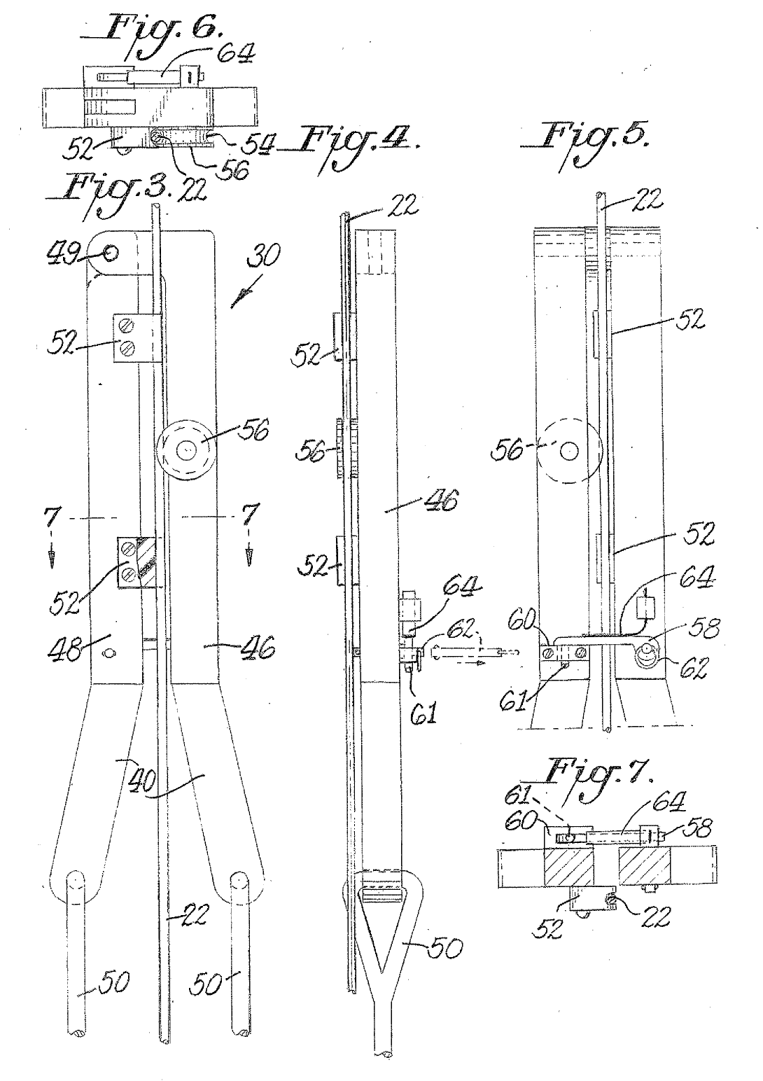

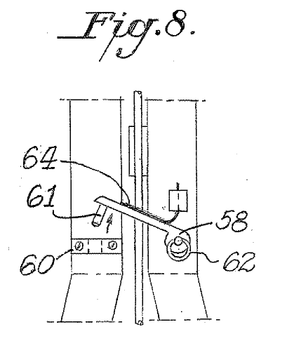

The system 10 could be practiced with any suitable form of clamp mechanism. FIGS. 3-8 show one possible form of clamp mechanism 30. As shown therein, clamp mechanism 30 includes a pair of clamp members 46,48 each of which terminates in a handgrip 40,40. The user controls the opening and closing of clamp mechanism 30 by pivoting the handgrips toward and away from each other. Clamp members 46,48 are pivoted together at pivot pin 49 so that the clamp members can be opened or closed by moving handgrips 40,40 toward and away from each other. The cable 22 passes longitudinally between the clamp members 46,48. Each handgrip 40,40 has a sling 50,50 attached which is connected to the safety harness 28. A pair of grooved blocks 52,52 is mounted to clamp member 48. FIG. 6 shows the groove 54 in each such block 52 for receiving the cable 22.

Clamp member 46 is provided with an adjustable tension wheel 56 which also is grooved for receiving cable 22 as shown, for example, in FIG. 4. Tension wheel 56 could be eccentrically mounted so that the degree of rotation about its pivot point varies or adjusts the degree of contact of tension wheel 56 with cable 22 to control the extent of friction or surface contact with cable 22 thereby controlling the rate of descent of clamp mechanism 30 down cable 22.

As shown in FIGS. 4-5 and 7-8, a self-locking latch mechanism is provided on clamp mechanism 30. The self-locking latch mechanism includes a self-locking latch 58 having a projection 61 which fits in a hole in grooved member 60. A spring 64 urges self-locking latch 58 into locking engagement with member 60. Latch 58 is pivotally mounted to clamp member 46 by a pivot pin which is connected to an externally disposed quick release ring 62. When the quick release ring 62 is pulled outwardly, latch 58 is no longer physically connected to clamp member 46 at that location. Since spring 64 is pressing against latch 58, latch 58 is moved in a clockwise direction and latch 58 is removed from the sliding groove member 60 to the condition shown in FIG. 8. The user can then open and release the clamp mechanism 30 from engagement with cable 22.

Although FIGS. 3-8 illustrate a form of clamping mechanism that is particularly useful with system 10 it is to be understood that other forms of clamp mechanisms could be used within the practice of this invention.

What is claimed is:

1. A tall structure external emergency escape system comprising a launching platform, a mounting assembly for mounting said platform to a structure to and from a first generally vertical position during periods of non-use for permitting said platform to generally conform to the external appearance of the structure and to and from a second generally horizontal position for supporting a person attempting to escape from the structure, a cable system mounted to said platform, said cable system including a cable having a fixed end and a free end, said fixed end being mounted to an anchor system on said platform, said free end being capable of extending downwardly from said platform to comprise a track on which the person may be lowered from said platform, a sling/harness for being worn by the person, and a clamp mechanism for attaching said sling harness to said cable for controlling the descendance of the person down said cable to a receiving area.

2. The system of claim 1 including an anchor member to which said free end of said cable may be attached to provide a rigid cable system.

3. The system of claim 2 wherein said anchor system includes a cable assembly for automatically unwinding said cable when said platform is in said generally horizontal position.

4. The system of claim 3 wherein said clamp mechanism includes structure for adjusting the tension of said clamp mechanism engaging said cable to control the rate of descent of the person down said cable.

5. The system of claim 4 wherein said clamp mechanism is of the quick release type for quickly disengaging said clamp mechanism from said cable.

6. The system of claim 5 wherein said mounting assembly includes pivot members for pivotally moving said platform to and from said first position and said second position.

7. The system of claim 6 including an escape opening in said platform, and said cable extending through said escape opening.

8. The system of claim 7 including a weight mounted to said free end of said cable.

9. The system of claim 7 including a cushion located at the receiving area.

10. The system of claim 7 wherein said platform is manually movable to and from said first position and said second position.

11. The system of claim 7 wherein said platform is movable by an external power source to and from said first position and said second position.

12. The system of claim 7 wherein said clamp mechanism includes an adjustable tensioning mechanism for controlling the rate of descent of the person down said cable.

13. The system of claim 12 in combination with said structure, said structure comprising a multi-story building, said platform having an upper surface on which the person would stand when said platform is in said second position, said platform having a lower surface opposite said upper surface, and said lower surface being an outer surface of said building when said platform is in said first position whereby said lower surface conforms to the exterior appearance of said building.

14. The system of claim 13 including a temporary window disposed externally in front of at least a portion of said platform when said platform is in said first position.

15. The system of claim 14 in combination with a plurality of said platforms disposed at different levels, and at least two of said platforms being generally vertically aligned with each other.

16. The system of claim 1 wherein said clamp mechanism includes structure for adjusting the tension of said clamp mechanism engaging said cable to control the rate of descent of the person down said cable.

17. The system of claim 1 wherein said clamp mechanism is of the quick release type for quickly disengaging said clamp mechanism from said cable.

18. The system of claim 1 wherein said mounting assembly includes pivot members for pivotally moving said platform to and from said first position and said second position.

19. The system of claim 1 in combination with said structure, said structure comprising a multi-story building, said platform having an upper surface on which the person would stand when said platform is in said second position, said platform having a lower surface opposite said upper surface, and said lower surface being an outer surface of said building when said platform is in said first position whereby said lower surface conforms to the exterior appearance of said building.

20. An emergency escape system comprising a launching platform, said platform having an escape opening extending completely therethrough, a cable system mounted to said platform, said cable system including a cable having a fixed end and a free end, said fixed end being mounted to an anchor system on said platform, said cable extending through said escape opening, a cable locking device mounted below said escape opening for securing said free end of said cable to said cable locking device, a sling/harness for being worn by a person, and a clamp mechanism attached to said sling/harness for detachable securement to said cable.

21. The system of claim 20 wherein said clamp mechanism is adjustable in tension to control the rate of descent down said cable, and said clamp mechanism being of the quick release type.

22. A clamping mechanism comprising a pair of clamp members pivotally joined together at one end, the opposite end of each of the said clamp members having a hand grip, said clamp members being disposed toward each other with the space therebetween when said clamp members are in a closed position, at least one guide block in said space for guiding a cable to which said clamping mechanism would be clamped, a tensioning wheel mounted to one of said clamp members in said space for engaging said cable, said tensioning wheel being adjustable in the degree of contact with the cable for adjusting the tension of said cable, a locking mechanism mounting said clamp members together in their closed position, and said locking mechanism including quick release structure whereby said clamp members are disposed in an unlocked condition by pulling a quick release ring which is part of said locking mechanism.

23. A method of escaping from a tall structure comprising providing an emergency escape system mounted externally of the structure with the emergency escape system having a launching platform disposed in a generally vertical position against the structure and conforming to the external appearance of the structure, lowering the platform to a generally horizontal position which provides access from the interior of the structure to the platform, unwinding a cable which is part of an anchor system mounted to the platform, unwinding the cable until the cable reaches a receiving area, placing a sling/harness on a person attempting to escape from the structure, connecting a clamp mechanism which is secured to the sling/harness to the cable after the lower end of the cable has been anchored at the receiving area, using the cable as a track by maintaining the clamp mechanism in engagement with the cable as the clamp mechanism moves downwardly on the cable while the person correspondingly descends from the platform, and activating a quick release mechanism which is part of the clamp mechanism to release the clamp mechanism from the cable when the person reaches the receiving area so that the person can leave the receiving area.
